(19) United States
(12) Patent Application Publication
(10) Pub. No.: US 2023/0409451 A1
(43) Pub. Date: Dec. 21, 2023

(54) GENERATING TEST DATA USING PRINCIPAL COMPONENT ANALYSIS

(71) Applicant: Tektronix, Inc., Beaverton, OR (US)

(72) Inventors: Justin E. Patterson, Honolulu, HI (US); Kan Tan, Portland, OR (US)

(73) Assignee: Tektronix, Inc., Beaverton, OR (US)

(21) Appl. No.: 18/211,410

(22) Filed: Jun. 19, 2023

Related U.S. Application Data
(60) Provisional application No. 63/353,956, filed on Jun. 21, 2022.

(51) Int. Cl. G06F 11/22

(52) U.S. Cl. CPC G06F 11/2268

(57) ABSTRACT

A system includes an input for accepting a dataset including at least two sets of data in a dataset domain and one or more processors configured to derive at least two principal components from the dataset using principal component analysis, the at least two principal components being orthogonal to one another, map the dataset to a principal component domain derived from the at least two principal components, generate additional data in the principal component domain, and remap the additional data in the principal component domain back to the dataset domain as a newly generated dataset. Methods of operation and description of storage media, the operation of which performs the above operations, are also described.

### CROSS-REFERENCE TO RELATED APPLICATIONS

This disclosure claims benefit of U.S. Provisional Application No. 63/353,956, titled “PRINCIPAL COMPONENT ANALYSIS FOR SIGNAL GENERATION,” filed on Jun. 21, 2022, the disclosure of which is incorporated herein by reference in its entirety.

### TECHNICAL FIELD

This disclosure relates to test and measurement instruments, and more particularly to using principal component analysis for signal generation.

### BACKGROUND

Test data is generated for a variety of purposes. It is generated to train machine learning (ML) workflows, which use large or very large amounts of data for training systems. Data may also be generated to model particular behavior of devices. Furthermore, data may be used as a primary step in generating particular test signals, such as those generated by an Arbitrary Waveform Generator (AWG). In all of these cases, modeling high-dimensional data is a complex task to ensure the generated data is accurate yet includes variability used for testing. Common approaches include treating observed measurements that form a basis for the generated data as independent, or by using complex math in the form of interpolating, line fitting, and perturbating, etc., to solve for relationships between particular measurements. Neither of these approaches are ideal, as they yield either inaccurate results or accurate results that require significant processing to achieve.

Embodiments according to the disclosure address these and other limitations found in conventional instruments.

### BRIEF DESCRIPTION OF THE DRAWINGS

FIG. 1 is a graph illustrating how a system using principal component analysis applies such analysis to a collection of data, according to embodiments of the disclosure.

FIG. 2 is a graph of a collection of data on which principal component analysis may be performed, according to embodiments of the disclosure.

FIGS. 3A and 3B are graphs of individual data of a dataset, and FIGS. 3C and 3D illustrate conventional methods of synthesizing data based on such data.

FIGS. 4A and 4B are graphs of a first and second principal component of the dataset of FIGS. 3A and 3B, and FIGS. 4C and 4D illustrate methods of synthesizing data using data generation methods in the principal component domain according to embodiments of the disclosure.

FIGS. 5A, 5B, and 5C illustrate an example of a conventionally generated dataset mapped against a dataset synthesized using data generation methods in the principal component domain, according to embodiments of the disclosure.

FIGS. 6A, and 6C illustrate an example of orthogonal measurement histograms and FIGS. 6B and 6D show principal component histograms used for data generation methods in the principal component domain according to embodiments of the disclosure.

FIG. 7 is a chart illustrating data generation methods in the principal component domain with a small number of device samples, according to embodiments of the disclosure.

FIG. 8 is an example flowchart illustrating operations for data and signal generation using the principal component domain according to embodiments of the disclosure.

FIG. 9 is a functional block diagram of a data generation system including principal component analysis, according to embodiments of the disclosure.

### DESCRIPTION

Embodiments of the invention include data generation or signal generation devices that generate output based on Principal Component Analysis (PCA) of an original dataset. PCA generally operates on large datasets, such as those generated by measurement data from a Device Under Test (DUT) or from other sources. Datasets used for PCA may also be retrieved from a database that stores previously gathered data. As a first step, performing PCA on these datasets provides insight about which variables contain the most information about the data, such as measurements included in the data. In general, PCA is a matrix decomposition of the data that allows the user to analyze and extract insights from measurements in a Principal Component (PC) domain, which may be a different domain than the measurement domain that produced the measurement data, or different from the original domain of the original dataset. In some respects, the ability of PCA to re-map data from the original domain into the PC domain is similar to a Fourier Transform recharacterizing data gathered, for instance in the time domain into measurements in the frequency domain. With PCA tools, the user may be able to discern relationships about particular measurements or related data that were not recognizable without PCA analysis. PCA analysis is particularly strong in analyzing multiple variables and determining which variables are correlated to one another. Then, as a second step after the PCA, the data is modified in some way within the PC domain itself to create modified data. Typically, but not always, the modified data is a larger dataset than the original data. Finally, the modified data is mapped from the PC domain back to the original domain, where it becomes a new set of data for testing, training, or various other uses. Specifics and variations of all of these steps and processes are described in detail below.

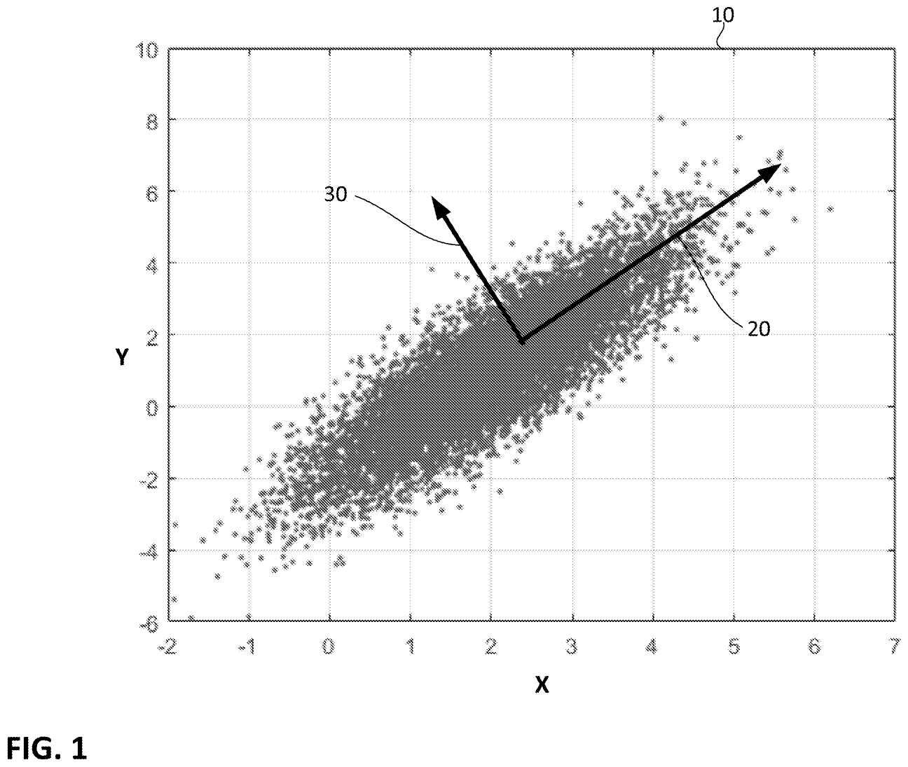

As mentioned above, PCA operates on sets of data. FIG. 1 is a chart 10 of data illustrating one of the basic fundamentals of PCA. Assume the data on the chart 10 is data that has an X component and a Y component. The data is mapped on chart 10 according to its XY components. PCA maps data from the measurement domain to a principal component domain through a coordinate transformation. To find the principal component axis, a Singular Value Decomposition is performed on the measurement data in a process described below. The principal component axis, in this case the axis 20, will always be the axis that has the maximum variance when the data from the dataset was projected onto that particular axis. To perform the Singular Value Decomposition on a set of data, one can envision generating an axis at an arbitrary orientation to the original data and projecting the dataset onto this arbitrary axis. The variance of the projected data for the present axis is recorded, and then the process repeats by projecting the original data to a new arbitrary axis. This process repeats through all possible axis orientations. When all possible axes have been produced, the variance data for each axis is analyzed to determine which axis has the largest variance when the original data was projected onto it. The axis that has the largest variance is the principal component axis. In other words, the principal component axis will point in the direction where the measurement data has the most variance. In the dataset of FIG. 1, the principal axis is labeled as axis 20 and is oriented in the direction of the most variable data. Other axes may be generated as well, one for each variable, or measurement in the data. In PCA, each of the principal axes is orthogonal to one another, so a secondary component axis 30 is orthogonal to the principal component axis 20, as illustrated in FIG. 1. PCA is particularly useful when measurements are linearly dependent, e.g., for Feed-Forward Equalizer taps as well as data that is carried on a signal having various levels. It should be noted that visualization of measurement data, including visualizations that use PCA analysis, becomes increasingly difficult when the number of measurements is three or more, but is a useful tool for analyzing a more modest number of measurements. One of the reasons PCA is useful in analyzing measurement data is that PCA produces hierarchical results of principal components. Then the user can systematically choose which principal components are to be used when modifying the data in the PC domain to generate additional datasets for training or for signal generation purposes.

Although many of the examples used herein refer to measurement data as the original data, embodiments according to the enclosure may use any type of data as the original data, and it is not limited to only measurement data types. There is a caveat, however, that, in order to use PCA on original data, the original data needs to include at least two sets of data.

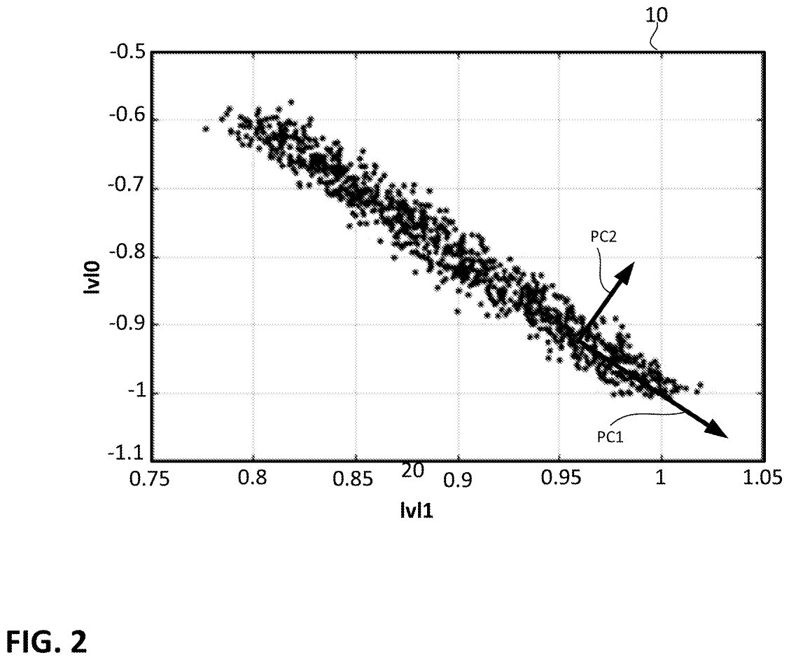

FIG. 2 illustrates measurement data gathered from a system with Non-Return-To-Zero coding having level measurements where the levels are linearly dependent, which will be used as an example of PCA. A level 1 (lvl1) value is graphed on the X axis while a level 0 (lvl0) value is graphed on the Y axis. This data is generated with 1000 pairs of linearly dependent data. In other words, the recorded measurements simultaneously move in opposite directions from a mean, according to Equation 1.

lvl1=x₁+xₙ

lvl0=x₀+xₙ Equation (1)

where, x₁ is uniformly distributed in the interval [0.8, 1], x₀=−2x₁+1, and xₙ is zero-mean gaussian noise with standard deviation of 0.1.

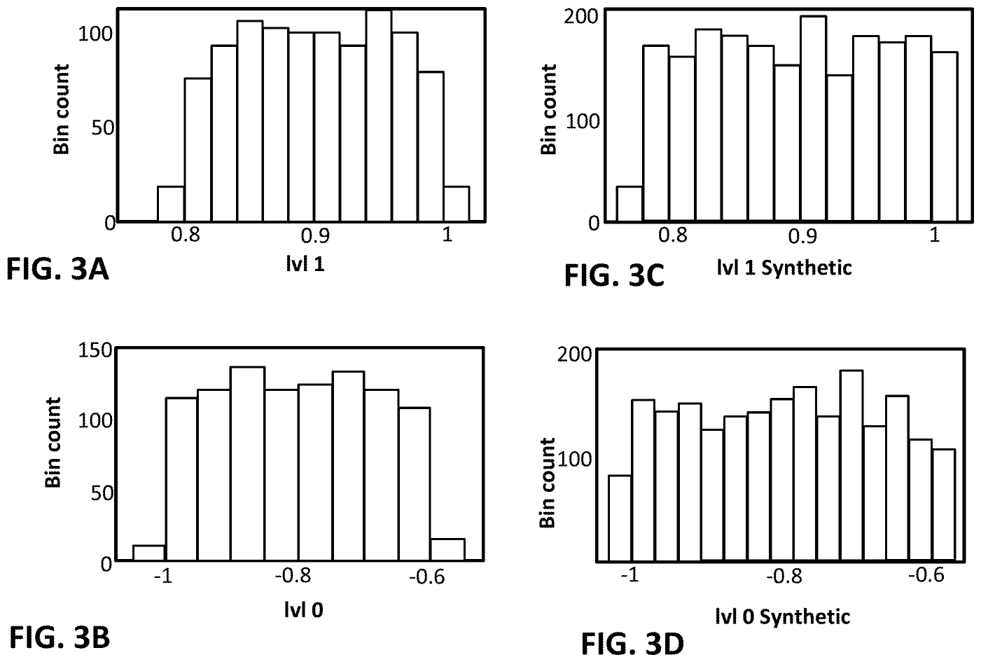

Traditional data analysis in the measurement domain of the measured data of FIG. 2 is illustrated in FIGS. 3A and 3B, where the chart in FIG. 3A illustrates various binned data of the measured value lvl 1 and the chart in FIG. 3B illustrates various binned data of the measured value lvl 0. FIGS. 3C and 3D illustrate that larger sets of data may be generated from this measured data using traditional methods, such as by drawing from the distribution. Specifically, FIG. 3C illustrates data that was traditionally synthesized from the data of FIG. 3A, and FIG. 3D illustrates data that was traditionally synthesized from the data of FIG. 3B. In general, traditional methods of generating this synthetic data for both lvl 1 and lvl 0 includes drawing from the distribution, interpolating, line fitting, perturbating, etc., as known in the art. Generating data in this traditional way assumes each of the measurements are independent to one another, as each of the synthesized data in FIGS. 3C and 3D was synthesized using only variations of a single variable, lvl 1 or lvl 0.

Using PCA on the recorded data, however, can reveal linear relationships within the data that are not recognizable using traditional tools. These relationships may be used later to advantageously generate large sets of synthesized data that more accurately reflect the relationships of the original data than do traditionally synthesized data.

First, to perform PCA, the principal components are extracted from the original measurement data using Singular Value Decomposition to determine the primary component axis, described above. Then, after the principal components are derived, the measurements originally gathered in the measurement domain are projected into the Principal Component (PC) domain, where each PC is a linear combination of the levels.

$$[ \begin{matrix}PC 1 \\ PC 2\end{matrix} ] = [ \begin{matrix}- \text{.4446} & \text{.8957} \\ \text{.8957} & \text{.4446}\end{matrix} ] ( [ \begin{matrix}lvl 1 \\ lvl 0\end{matrix} ] - [ \begin{matrix}lvl 1 mean \\ lvl 0 mean\end{matrix} ] ) \qquad Equation ( 2 )$$

For example, using Equation 2, the levels [1, −1] V gets mapped to [−0.223, 0.0002].

The Principal Component 1 axis (PC1) and Principal Component 2 Axis (PC2) are illustrated in FIG. 2, which were determined by performing the PCA on the measurement data in FIG. 2 according to Equation 2. Note that the PC2 axis 30 in FIG. 2 is orthogonal to the PC1 axis 20.

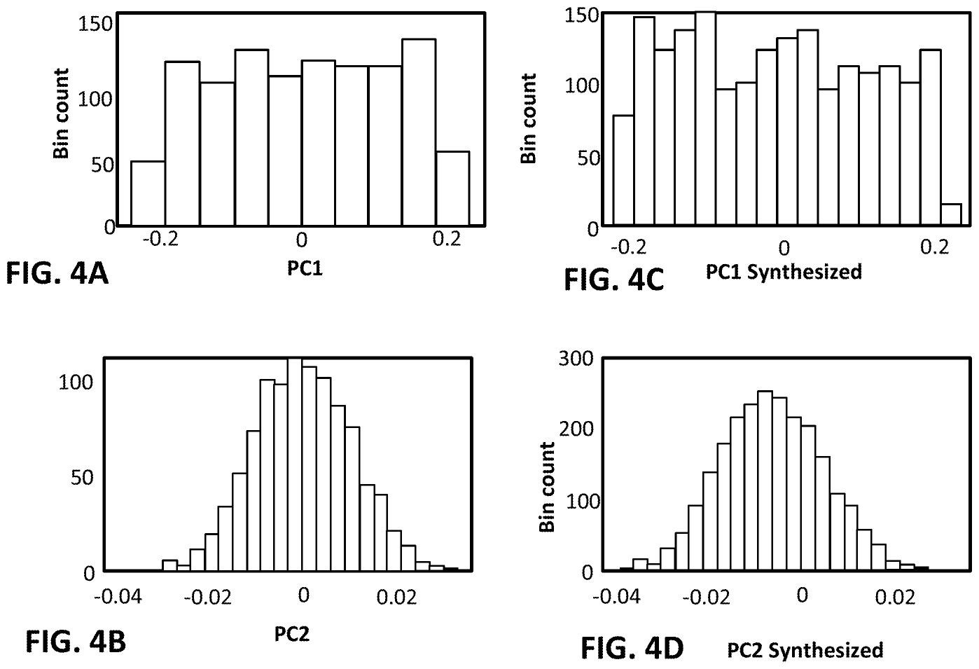

After the principal components, and therefore the PC domain are derived, and after the original measurement data has also been projected into the PC domain, data analysis not possible with only the original data may proceed. For instance, histograms may be generated on the PC domain data. FIG. 4A shows measurement histograms for the original data mapped into the first principal component, PC1, while FIG. 4B shows histograms for the measurement data after it has been projected onto the second principal component PC2. Recall from above that PC2 is orthogonal to PC1.

Unlike the plots FIGS. 3A and 3B, which provided little information about the original measurement data, the histograms illustrated in FIGS. 4A and 4B provide useful information about the measured data, such as patterns that are revealed when binning transformed data. The binning data for PC1 graphed in FIG. 4A illustrates that most of the center bins have approximately the same measurements per bin, meaning that the data has a relatively uniform distribution along the PC1. Noticeably different is the binning data for PC2, which is graphed in FIG. 4B. This data appears more like a Gaussian distribution, with many more data values falling in the central bins rather than the extremes. Importantly, both relatively uniform types of data, as seen in FIG. 4A as well as data that shows Gaussian distribution characteristics such as seen in FIG. 4B are recognized as being ‘standard’ types of distributions of data. When data in the PC domains are standard types of distributions, new datasets may be generated directly in the principal component domain by generating new data that fits within either of these types of distributions. For example, the PC1 synthesized data illustrated in FIG. 4C shows many more histograms each having relatively uniform distribution compared to the original data of FIG. 4A. Similarly, the PC2 synthesized data illustrated in FIG. 4D shows a histogram having bins that approximate the original PC2 Data illustrated in FIG. 4B but differs in that additional data is generated for the data in FIG. 4D. Methods of generating new datasets from original data in individual PC domains that have a standard distribution includes drawing directly from the distribution in the PC domain. Furthermore, it is possible to generate data from the original data in the individual PC domains that does not have a standard distribution. For the non-standard distribution, methods of generating additional datasets include interpolating, line fitting, and perturbating, etc., in the individual PC domains.

After the new datasets have been generated in the PC domain, they may be mapped back into the original domain of the source of the data.

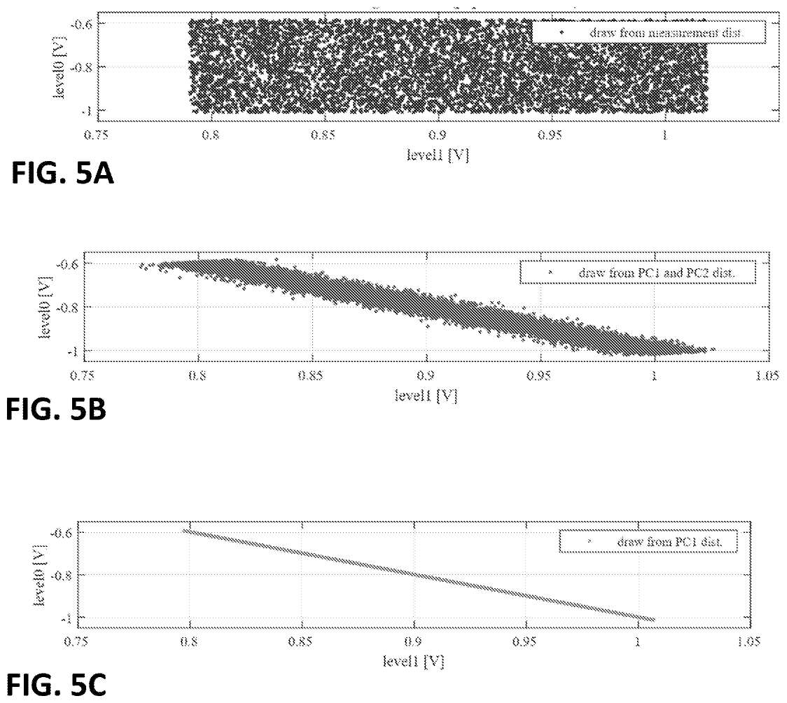

FIGS. 5A, 5B, and 5C illustrate benefits of synthesizing data sets using PCA and then remapping the synthesized data back into the original domain. FIG. 5A shows synthesized data that was drawn from a measurement distribution, like described above with reference to FIGS. 3C and 3D. Note how the data is does not follow the original dataset illustrated in FIG. 2, but rather is extremely variable and appears almost random in nature. This occurred because it assumed that the measurements for lvl 1 and lvl 0 were independent, and were independently synthesized, but in reality, they were related to one another, as the PCA showed. FIG. 5B shows synthesized data that was drawn in the PC domain, and specifically drawn from both PC1 and PC2 distributions of FIGS. 4C and 4D. Finally, FIG. 5C shows data that was also synthesized from the PC domain, but was drawn from only PC1, which, as described above, is the principal component from the original dataset. PC2 is set to 0. The datasets illustrated in FIGS. 5B and 5C, i.e., the datasets drawn in the PC domain and remapped back into the original domain are associated much more closely with the original dataset illustrated in FIG. 2, especially when compared to the dataset generated from drawing from a measurement distribution of FIG. 5A. These new datasets generated using embodiments of the disclosure may be used for a variety of purposes, such as training machine learning systems, or modeling multiple devices from observing only a subset of the devices. Given how closely data generated according to embodiments of the disclosure tracks the additional data. In some cases, modifying data from a first device using the above-described methods may have purpose for generating a digital twin of a second device, even without making measurements from the second device.

Another use for generating new datasets that closely resemble original datasets includes generating signals, such as with an Arbitrary Wave Generator (AWG). Just as generating a dataset that is close but different from an original set of data, generating a signal that is close but different from an original signal is useful. For example, a signal from a first device may be measured and translated into an original set of data that describes the signal. Then, using PCA techniques described above, embodiments according to the disclosure may be used to generate a different set of data that closely resembles the original set, yet is different. Then, translating this synthesized set of data back into a signal enables a device, such as an AWG, to generate multiple different signals that are different from, yet based on, the original signal. Thus, such an AWG could be used to generate multiple different signals for edge testing or testing different parameters of a device, based on an original signal from the device.

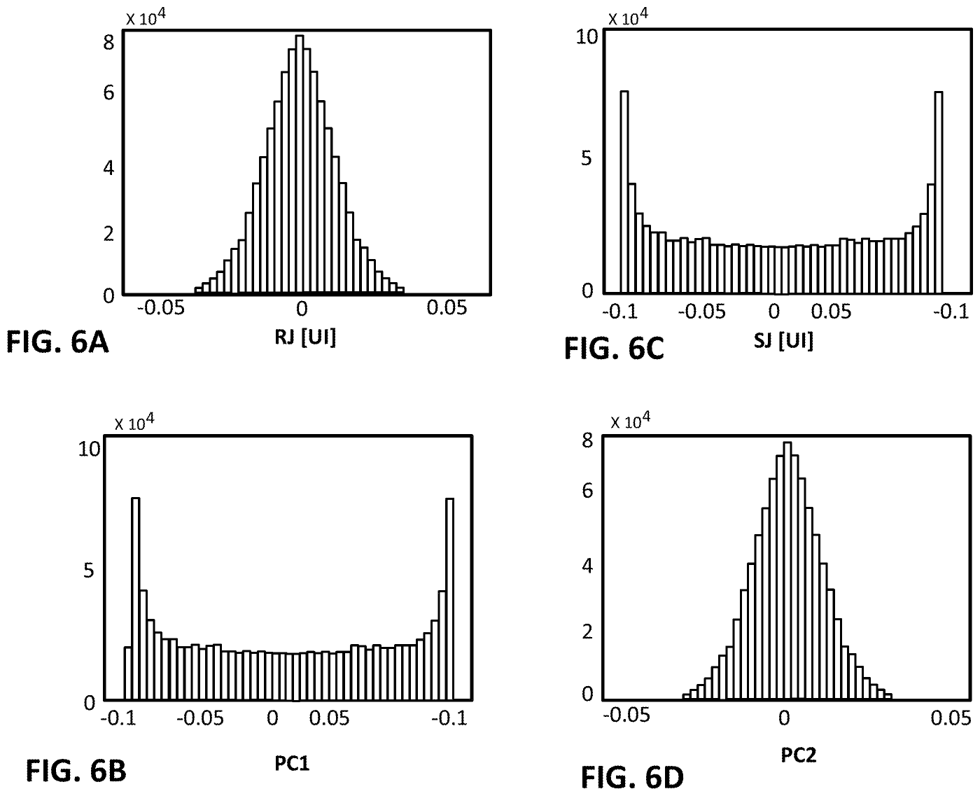

FIGS. 6A-6D illustrate another example of measurements and how they related to one another in the PC domain. FIGS. 6A and 6C show the histograms in the measurement domain for Random Jitter (RJ) and Sinusoidal Jitter (SJ), which are orthogonal measurements to one another. When PCA is computed on RJ and SJ, notice that PC1 is equal to SJ and PC2 is equal to RJ. In this example, SJ is assigned to PC1 because it has more variation. Thus, when the measurements are orthogonal, drawing from the PC distribution to generate new datasets is equivalent to drawing from the measurement distribution to make new datasets.

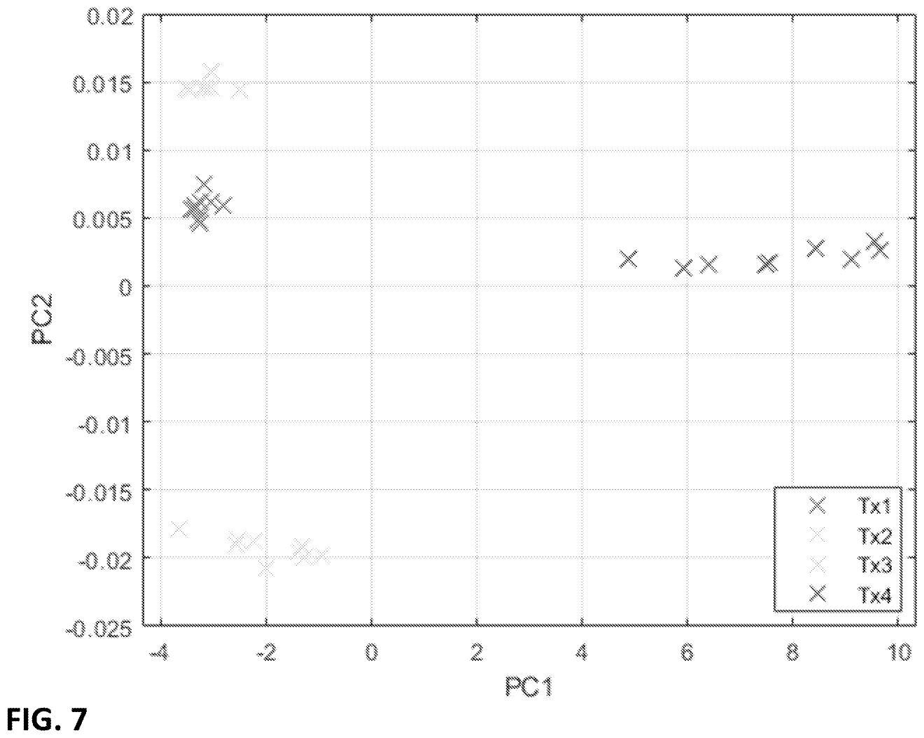

FIG. 7 illustrates yet another example of generating datasets using operations in the PC domain. This figure shows the first two principal components, PC1 and PC2 for four devices. In this example, there are only nine samples per device, which is a limited number of samples for statistical analysis to generate datasets. In the case of limited samples, the distribution is generally not “standard,” as it has an arbitrary shape. As an example, if the goal is to synthesize datasets approximating 200 devices from the four measured devices, embodiments according to the disclosure can generate 50 perturbations to each device, to get a total of 200 devices. As in the previous examples, the perturbation is performed in the principal component domain.

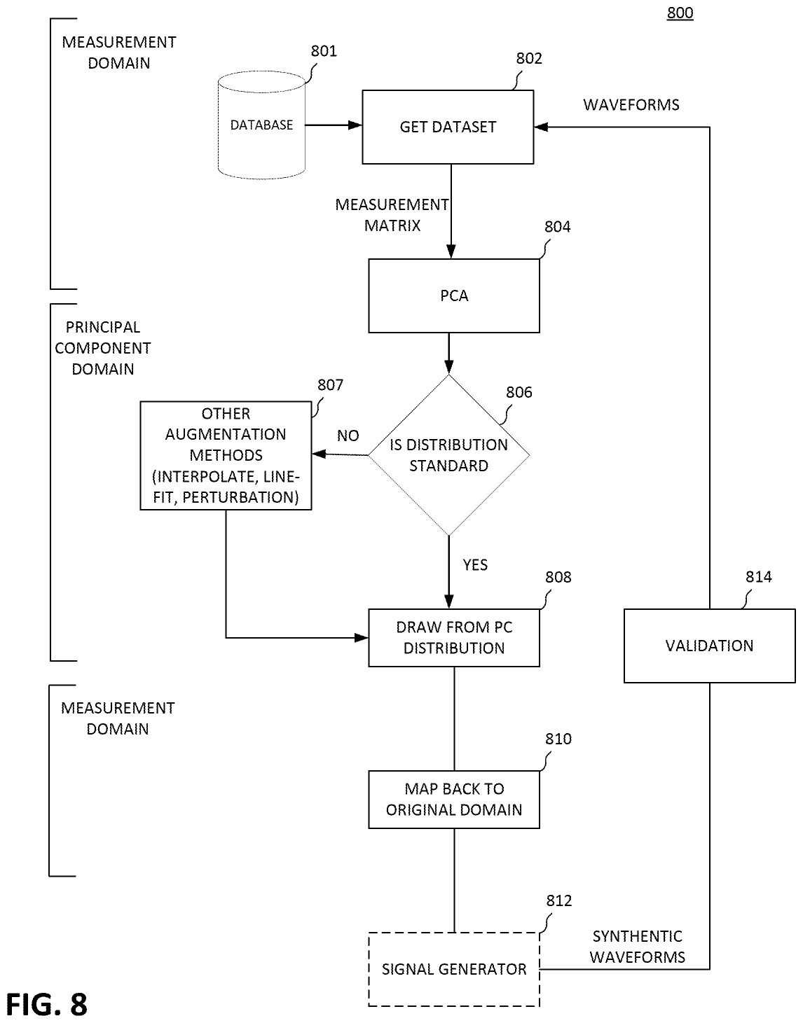

FIG. 8 is an example flow diagram showing operations for generating test data using principal component analysis according to embodiments of the disclosure. A flow 800 begins at an operation 802 with procuring a set of original data including at least two sets of data or measurements. The original two sets of data may be test data, measurement data, or any type of data. Data may be received from another device, such as a DUT, or may be retrieved from a database of previously stored data 801. Once the data is gathered, PCA is performed on the data in an operation 804, translating the original data from its original domain to a principal component domain, as described above. The number of principal components that can be generated is limited to the number of independent sets or measurements within the original data. For example, if the original data included three measurements, then up to three principal components may be generated using the above processes.

After the original data is mapped to the PC domain in operation 804, the data is analyzed in the PC domain in an operation 806 to determine whether the data for a particular domain is a standard distribution. Recall from above that standard distributions include uniform or gaussian distributions, or distributions that approximate these standard distributions. If the data for a particular domain is a standard distribution, then new data is generated in the PC domain in an operation 808. An example of this was provided above with reference to FIGS. 4A-4D. If instead the data for a particular domain is not a standard distribution, then the data is augmented in the PC domain in an operation 807. Such an augmentation may include perturbing a variable or using interpolation or line fitting to modify the data in the PC domain. An example of perturbation in the PC domain was provided above with reference to FIGS. 6A-6D. Once augmented in the operation 807, then new data may be generated in the PC domain as described above.

Next, no matter how the new data was generated in the PC domain, i.e., using either operations 807 or 808, then the newly generated data is mapped back to its original domain in an operation 810. This operation is processed by using an inverse matrix of the type used to generate the PC domain, and then adding back the mean values used in Equation 2.

In some embodiments, the flow 800 stops with the newly generated data, which may be used for the variety of purposes described herein. In other embodiments, the newly generated data is used to generate signals. In these embodiments, new signals are generated in an operation 812. Signals are generally generated in the operation 812 when measurements of signals were used to produce the original datasets gathered in operation 802. Finally, the signals generated in operation 812, which may be referred to as synthetic waveforms because they were synthesized using embodiments of the disclosure, are validated. This validation may include ensuring the synthetic waveforms conform to certain requirements, such as maximum voltages, minimum or maximum timings, etc. Although not illustrated in FIG. 8, the synthetic waveforms, or data used to generate the synthetic waveforms in operation 812 may be stored in the database of stored data 802 to be used again.

Thus, using techniques described above, any desired amounts of test data may be generated using PCA from original datasets. The generated datasets accurately reflect the original datasets, meaning that the generated datasets preserve the correlations in data of the original datasets.

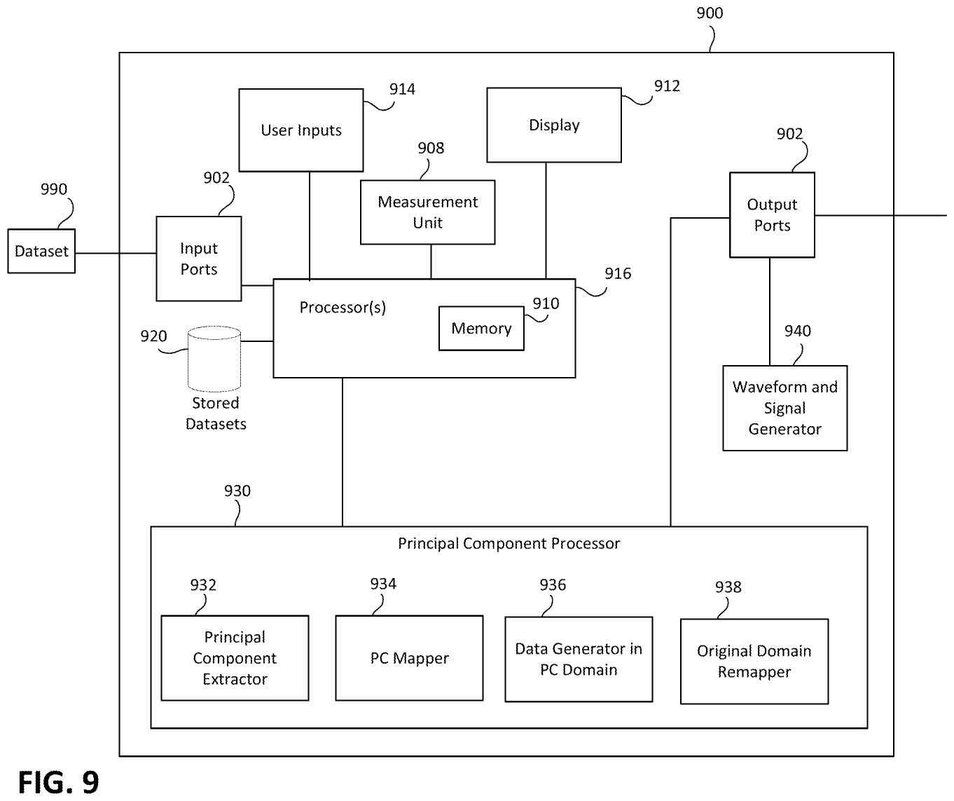

Embodiments of the disclosure operate on particular hardware and/or software to implement the above-described PCA operations. FIG. 9 is a block diagram of an example system 900 for generating datasets from an original dataset. The system 900 may be a test and measurement instrument, such as an oscilloscope or spectrum analyzer. The system may instead be an Arbitrary Waveform Generator. The system 900 may instead be implemented using cloud processing. The system 900 may take many forms depending on the implementation details. The system 900 may include one or more ports 902 for receiving a dataset. In some embodiments the dataset is imported into the system 900 directly through the input port 902. In other embodiments the dataset is in the form of an input signal, in which case the ports 902 may include receivers, and/or transceivers.

The ports 902 are coupled with one or more processors 916 to process the datasets and/or signals received at the ports 902. Although only one processor 916 is shown in FIG. 9 for ease of illustration, as will be understood by one skilled in the art, multiple processors 916 of varying types may be used in combination in the instrument 900, rather than a single processor 916.

The ports 902 may be connected to a measurement unit 908 in the test instrument 900. The measurement unit 908 can include any component capable of measuring aspects (e.g., voltage, amperage, amplitude, power, energy, etc.) of a signal received via ports 902. The test and measurement instrument 900 may include additional hardware and/or processors, such as conditioning circuits, analog to digital converters, and/or other circuitry to convert a received signal to a waveform for further analysis. This measurement unit 908 generates a dataset, including two or more sets of data, for use by the one or more processors 916, and/or for use by the principal component processor 930 described below.

In some embodiments the dataset is neither retrieved through an input port 902 nor measured from a signal received through the input port, but rather is retrieved from a dataset store 920, which may be within the system 900, or may be an external database.

The one or more processors 916 may be configured to execute instructions from the memory 910 and may perform any methods and/or associated steps indicated by such instructions, such as displaying and modifying the input signals received by the instrument. The memory 910 may be implemented as processor cache, random access memory (RAM), read only memory (ROM), solid state memory, hard disk drive(s), or any other memory type. The memory 910 acts as a medium for storing data, such as acquired sample waveforms, computer program products, and other instructions.

User inputs 914 are coupled to the processor 916. User inputs 914 may include a keyboard, mouse, touchscreen, and/or any other controls employable by a user to set up and control the instrument 900. User inputs 914 may include a graphical user interface or text/character interface operated in conjunction with the display 912. The user inputs 914 may receive remote commands or commands in programmatic form, either on the instrument 100 itself, or from a remote device. The display 912 may be a digital screen, a cathode ray tube-based display, or any other monitor to display waveforms, measurements, and other data to a user. While the components of test instrument 900 are depicted as being integrated within test and measurement instrument 900, it will be appreciated by a person of ordinary skill in the art that any of these components can be external to test instrument 900 and can be coupled to test instrument 900 in any conventional manner (e.g., wired and/or wireless communication media and/or mechanisms). For example, in some embodiments, the display 912 may be remote from the test and measurement instrument 900, or the instrument may be configured to send output to a remote device in addition to displaying it on the instrument 900. In further embodiments, output from the measurement instrument 900 may be sent to or stored in remote devices, such as cloud devices, that are accessible from other machines coupled to the cloud devices.

The instrument 900 may include a principal component processor 930, which may be a separate processor from the one or more processors 916 described above, or the functions of the principal component processor 930 may be integrated into the one or more processors 916. Additionally, the principal component processor 920 may include separate memory, use the memory 910 described above, or any other memory accessible by the instrument 900. The principal component processor 920 may include specialized processors or operations to implement the functions described above. For example, the principal component processor 920 may include a principal component extractor 932 used to perform principal component analysis on the dataset, which may include measurement data. The principal component extractor 932 may perform the singular value decomposition process on the original dataset described above. Then a principal domain mapper 934 maps the original dataset data from the dataset domain to the principal component domains derived by the principal component extractor 932. The dataset domain means the domain the data was originally in. For example, the domain may be a measurement domain for measured data. Once the dataset data has been mapped to the principal component domains, a data generator 936 generates further data in the principal component domain, as described above. Then, after the new data has been generated, an original domain remapper 938 remaps the data from the principal domain, including the new data generated by the data generator 936, back into the original domain of the original dataset. Thus, the principal component processor generates synthesized datasets that closely follow original datasets, preserving relationships.

Any or all of the components of the principal component processor 930, including the principal component extractor 932, principal domain mapper 934, data generator 936, and the original domain remapper 938 may be embodied in one or more separate processors, and the separate functionality described herein may be implemented as specific pre-programmed operations of a special purpose or general-purpose processor. Further, as stated above, any or all of the components or functionality of the principal component processor 930 may be integrated into the one or more processors 916 that operate the system 900.

Aspects of the disclosure may operate on a particularly created hardware, on firmware, digital signal processors, or on a specially programmed general-purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### Examples

Illustrative examples of the disclosed technologies are provided below. An embodiment of the technologies may include one or more, and any combination of, the examples described below.

Example 1 is a system including an input for accepting a dataset including at least two sets of data in a dataset domain and one or more processors configured to derive at least two principal components from the dataset using principal component analysis, the at least two principal components being orthogonal to one another, map the dataset to a principal component domain derived from the at least two principal components, generate additional data in the principal component domain, and remap the additional data in the principal component domain back to the dataset domain as a newly generated dataset.

Example 2 is a system according to Example 1, in which the additional data generated in the principal component domain is generated from data having a standard distribution in the principal component domain.

Example 3 is a system according to any of the previous Examples, in which the additional data generated in the principal component domain is generated from data having a non-standard distribution in the principal component domain.

Example 4 is a system according to any of the previous Examples, further comprising a signal generator.

Example 5 is a system according to Example 4, in which the signal generator is configured to generate a signal from the newly generated dataset.

Example 6 is a system according to Example 5, in which the dataset including at least two sets of data was generated from an original signal received at the input.

Example 7 is a system according to Example 6, further comprising a measurement unit configured to measure a signal received at the input.

Example 8 is a system according to Example 5, in which the system further includes a signal validator structured to ensure the generated signal conforms to one or more signal definitions.

Example 9 is a method comprising accepting a dataset including at least two sets of data in a dataset domain, deriving at least two principal components from the dataset using principal component analysis, the at least two principal components being orthogonal to one another, mapping the dataset to a principal component domain derived from the at least two principal components, generating additional data in the principal component domain, and remapping the additional data in the principal component domain back to the dataset domain as a newly generated dataset.

Example 10 is a method according to Example method 9, in which the additional data generated in the principal component domain is generated from data having a standard distribution in the principal component domain.

Example 11 is a method according to any of the previous Example methods, in which the additional data generated in the principal component domain is generated from data having a non-standard distribution in the principal component domain.

Example 12 is a method according to any of the previous Example methods, further comprising generating a signal from the newly generated dataset.

Example 13 is a method according to any of the previous Example methods, further comprising generating the dataset including at least two sets of data from an input signal.

Example 14 is a method according to any of the previous Example methods, further comprising accepting an input signal, performing one or more measurements on the input signal, and generating the dataset including at least two sets of data from the one or more measurements of the input signal.

Example 15 is a method according to Example method 12, further comprising validating the generated signal against one or more signal definitions.

Example 16 is a non-transitory computer-readable storage medium storing one or more instructions, which, when executed by one or more processors of a computing device, cause the computing device to accept a dataset including at least two sets of data in a dataset domain, derive at least two principal components from the dataset using principal component analysis, the at least two principal components being orthogonal to one another, map the dataset to a principal component domain derived from the at least two principal components, generate additional data in the principal component domain, and remap the additional data in the principal component domain back to the dataset domain as a newly generated dataset.

Example 17 is a non-transitory computer-readable storage medium according to claim 16, wherein execution of the one or more instructions causes the computing device to generate additional data in the principal component domain using data having a standard distribution in the principal component domain.

Example 18 is a non-transitory computer-readable storage medium according to any preceding storage medium Example, wherein execution of the one or more instructions causes the computing device to generate additional data in the principal component domain using data having a non-standard distribution in the principal component domain.

Example 19 is a non-transitory computer-readable storage medium according to any preceding storage medium Example, wherein execution of the one or more instructions causes the computing device to generate a signal from the newly generated dataset.

Example 20 is a non-transitory computer-readable storage medium according to Example 19, wherein execution of the one or more instructions causes the computing device to validate the generated signal to ensure the generated signal conforms to one or more signal definitions.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

We claim:

1. A system, comprising:
an input for accepting a dataset including at least two sets of data in a dataset domain; and
one or more processors configured to:
derive at least two principal components from the dataset using principal component analysis, the at least two principal components being orthogonal to one another,
map the dataset to a principal component domain derived from the at least two principal components,
generate additional data in the principal component domain, and
remap the additional data in the principal component domain back to the dataset domain as a newly generated dataset.

2. The system according to claim 1, in which the additional data generated in the principal component domain is generated from data having a standard distribution in the principal component domain.

3. The system according to claim 1, in which the additional data generated in the principal component domain is generated from data having a non-standard distribution in the principal component domain.

4. The system according to claim 1, further comprising a signal generator.

5. The system according to claim 4, in which the signal generator is configured to generate a signal from the newly generated dataset.

6. The system according to claim 5, in which the dataset including at least two sets of data was generated from an original signal received at the input.

7. The system according to claim 6, further comprising a measurement unit configured to measure a signal received at the input.

8. The system according to claim 5, in which the system further includes a signal validator structured to ensure the generated signal conforms to one or more signal definitions.

9. A method, comprising:
accepting a dataset including at least two sets of data in a dataset domain;
deriving at least two principal components from the dataset using principal component analysis, the at least two principal components being orthogonal to one another;
mapping the dataset to a principal component domain derived from the at least two principal components;
generating additional data in the principal component domain; and
remapping the additional data in the principal component domain back to the dataset domain as a newly generated dataset.

10. The method according to claim 9, in which the additional data generated in the principal component domain is generated from data having a standard distribution in the principal component domain.

11. The method according to claim 9, in which the additional data generated in the principal component domain is generated from data having a non-standard distribution in the principal component domain.

12. The method according to claim 9, further comprising generating a signal from the newly generated dataset.

13. The method according to claim 9, further comprising generating the dataset including at least two sets of data from an input signal.

14. The method according to claim 9, further comprising:
accepting an input signal;
performing one or more measurements on the input signal; and
generating the dataset including at least two sets of data from the one or more measurements of the input signal.

15. The method according to claim 12, further comprising validating the generated signal against one or more signal definitions.

16. A non-transitory computer-readable storage medium storing one or more instructions, which, when executed by one or more processors of a computing device, cause the computing device to:
accept a dataset including at least two sets of data in a dataset domain;
derive at least two principal components from the dataset using principal component analysis, the at least two principal components being orthogonal to one another;
map the dataset to a principal component domain derived from the at least two principal components;
generate additional data in the principal component domain; and
remap the additional data in the principal component domain back to the dataset domain as a newly generated dataset.

17. The non-transitory computer-readable storage medium according to claim 16, wherein execution of the one or more instructions causes the computing device to generate additional data in the principal component domain using data having a standard distribution in the principal component domain.

18. The non-transitory computer-readable storage medium according to claim 16, wherein execution of the one or more instructions causes the computing device to generate additional data in the principal component domain using data having a non-standard distribution in the principal component domain.

19. The non-transitory computer-readable storage medium according to claim 16, wherein execution of the one or more instructions causes the computing device to generate a signal from the newly generated dataset.

20. The non-transitory computer-readable storage medium according to claim 19, wherein execution of the one or more instructions causes the computing device to validate the generated signal to ensure the generated signal conforms to one or more signal definitions.
